(19) United States
(12) Patent Application Publication
(10) Pub. No.: US 2002/0187790 A1
(43) Pub. Date: Dec. 12, 2002

(54) Non-dedicated access node and switch connections in a wireless telecommunications network

(76) Inventors: Dimitrios Papadimitriou, Dallas, TX (US); Jo Kuster, Prosper, TX (US); Klaus Turina, Backnang (DE)

Correspondence Address: Arthur I. Navarro, Godwin White & Gruber, 801 E. Campbell Rd. Suite 655, Richardson, TX, 75081, US

(21) Appl. No.: 09/879,451

(22) Filed: Jun. 12, 2001

(51) Int. Cl. H04Q 7/20

(52) U.S. Cl. 455/452; 455/450; 455/422

(57) ABSTRACT

A telecommunications network (20) provides non-dedicated circuit connections between access nodes and switches of the network. A switch pool (24) enables the switches to communicate with access nodes disposed about a service area of the telecommunications network. The invention also provides methods of providing non-dedicated circuit pathways between access nodes (12a . . . n) and switches (14a . . . n) in a telecommunications network (20) having a plurality of gateways (28(a),28(b)). A media gateway selection node (22) provides a circuit connection mechanism and uses a gateway selection database (26) as a means for storing and accessing data and means for defining relationships among the media gateways (28(a), 28(b)), access nodes (12(a . . . n)) and switches (14(a . . . n)).

### TECHNICAL FIELD

This invention relates in general to telecommunications networks and more particularly to non-dedicated connections between switches and access nodes in a wireless network. More particularly, the invention relates to providing systems and methods for dynamically allocating connections between switches and access nodes in a wireless telecommunications network using mobile switching center pool.

### BACKGROUND OF THE INVENTION

The increasing demand for wireless telecommunication services has resulted in the growth of many wireless telecommunication systems and increase in the number of roaming wireless subscribers. Some efforts implemented to accommodate and distribute the increased traffic load in the wireless telecommunications networks propose that the traffic load be distributed among a number of mobile switching centers interconnected such that they constitute a mobile switching center pool (MSC pool) for the network. Such an MSC pool offers many advantages to both subscriber and network/service provider in the form of more efficient utilization of network resources. Among the advantages realized by the use of the MSC pool include load sharing network components and increased capacity and/or coverage in areas where the addition of an individual switching element would be cost prohibitive.

There are, however, known limitations and disadvantages of an MSC pool. One disadvantage is the large number of dedicated circuits that are required in order to provide communications between the various access nodes in the network such as, for example, Base Station Controllers (BSCs) and individual MSCs of the MSC pool. The most obvious way to connect access nodes to the MSCs is to provide a dedicated circuit from each BSC to each MSC in the pool but this results in high expense and inefficiency. Moreover, the use of dedicated circuits requires major upgrade and/or expense every time a new node is introduced or removed from the network. Also, since traffic capacity is fixed by the capacity of the dedicated circuits, networks must be constructed for peak loads resulting in unused capacity during non-peak times.

Accordingly, a non-dedicated access connection between nodes of a telecommunications network using an MSC pool would provide numerous advantages. Such non-dedicated access connection would make possible the dynamic allocation of circuit between switches and access nodes, such as BSCs, of the network. The addition or removal of switches in such a network would easily be accommodated, with better load distribution.

### SUMMARY OF THE INVENTION

The invention provides a telecommunications network with non-dedicated circuit pathways between access nodes and switches of the network. A MSC pool, or switch pool, enables individual switches of the pool to communicate with access nodes disposed about a service area of the telecommunications network. Gateways supply connections between the access nodes and the switch pool via numerous circuit pathways. A gateway selection node is provided and adapted to reserve and release circuit pathways as needed for use between switches of the switch pool and the access nodes.

The invention also provides a method of providing non-dedicated circuit pathways between access nodes and switches in a telecommunications network having a plurality of gateways. The method includes the steps of selecting a circuit pathway between a switch and a target access node and allocated such a circuit pathway as needed. The circuit pathway is subsequently de-allocated making it available for reuse for reuse by another access node.

A media gateway selection node of the invention is provided for use in a telecommunications network. The media gateway selection node makes available non-dedicated circuit pathways between individual access nodes and switches of a switch pool in the network. The media gateway selection node includes means for storing and accessing data and means for defining relationships among the media gateways, access nodes, switches, and circuit pathways of the network. Functions performed with the stored data reserve and release circuit pathways as needed for use between individual switches and individual access nodes of the network.

Many technical advantages are achieved with the invention including simplifying and improving the implementation of a switch pool in a Public Land Mobile Network (PLMN). A particular advantage is the ability to add and remove switches without necessitating changes in surrounding nodes and or installing new circuits dedicated to the access function.

An additional advantage is the ability to dynamically allocate circuit paths within the network in order to accommodate changing network traffic or hardware conditions. Further advantages will become apparent to those skilled in the arts upon review of the following description and claims.

### BRIEF DESCRIPTION OF THE DRAWINGS

The above advantages, as well as specific embodiments of the present invention, will be more clearly understood from consideration of the following descriptions in connection with accompanying drawings in which:

FIG. 1 is a block diagram depicting the relationship among switches and access nodes in a prior art PLMN using a switch pool;

FIG. 2 is a block diagram of an example of a PLMN having a switch pool and using the invention;

FIG. 3 depicts a table illustrating an example of a media gateway selection database in accordance with FIG. 2; and

FIG. 4 is a process flow diagram of the steps of the invention of FIGS. 2 and 3.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with PLMNs, switches, and access nodes of various types and in various configurations. Some features of embodiments shown and discussed are simplified or exaggerated for illustrating the principles of the invention.

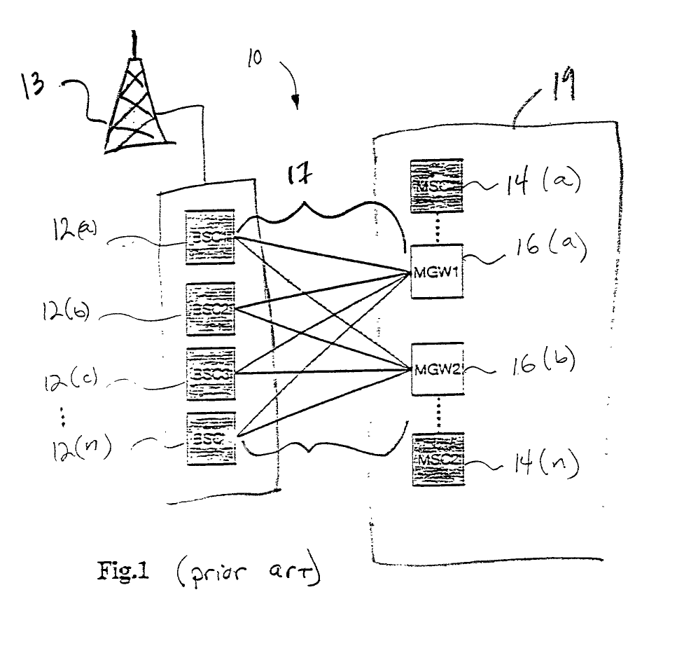

With reference now to FIG. 1, therein is shown a generalized block diagram of a telecommunications network illustrating the relationship among switches and access nodes in a state-of-the-art PLMN utilizing a switch pool. In this example, PLMN 10 is described as conforming to the Global System for Mobile Communications (GSM) standard, although the principles disclosed may have application to other wireless networking systems such as those based on Code Division Multiple Access (CDMA), Wideband CDMA (WCDMA), Enhanced Data for GSM Evolution (EDGE), and other wireless standards known to those of ordinary skill.

The solid lines connecting elements of FIG. 1 represent bearer connections while the dashed lines represent signal connections. The PLMN 10 has numerous Base Station Controllers (BSCs) 12(a . . . n) which act as access nodes to other network elements such as, for example, Base Transceiver Station 13, which in turn serve individual mobile terminals (not shown) of the network 10. Mobile Switching Centers (MSCs) 14(a . . . n) provide well known switching and call control functions for the PLMN 10. Also, the MSCs 14(a . . . n) may operate collectively as an MSC pool 19 such that any one MSC 14(a . . . n) in the MSC pool 19 may be used to advantageously to provide call control and switching functions, as is well known to those of ordinary skill in the art.

A limitation of the system of FIG. 1, are the dedicated circuit connections 17 which are used between each BSC 12(a . . . n) and corresponding gateway elements 16(a), 16(b) to provide the interface to MSCs 14(a . . . n), respectively. The physical links embodying dedicated circuits 17 provide the connecting mechanism to individual BSCs 12(a . . . n) and to individual MSCs 14(a . . . n) via the Media Gateways MGW 16(a), 16(b).

In practice, each MSC 14(a . . . n) controls sets of circuits at its respective MGW 16a or 16(b), one set corresponding to each BSC 12(a . . . n) of the network 10. Each BSC has a dedicated set of Circuit Identity Codes (CICs) that communicate with the MSCs in the pool 19. Each MGW 16(a), 16(b) has termination points where the dedicated circuit 17 from any one BSC (12a . . . 12n) terminate. In this way, any MSC 14(a . . . n) is able to communicate with any BSC 12(a . . . n), and vice versa, at any given time.

While the configuration shown in FIG. 1 does provide a reliable connection scheme between nodes of a telecommunications network, such as telecommunications network 10, the fact that the connections 17 are dedicated introduces some significant limitations. First, a large number of dedicated circuits are typically required in order to provide communications between the various access nodes in the network such as, for example, BSCs 12(a . . . n) and individual MSCs 14(a . . . n). Thus, the dedicated circuit connections 17 from each BSC 12(a . . . n), or other access node, to each MSC (14a . . . n) in the pool results in high expense and inefficiency. Moreover, the use of dedicated circuits 17 requires major upgrade and/or expense every time a new access node is introduced or removed from the network. For example, every time an MSC is added or removed from the pool 19, CICs must also be added or removed and the BSCs must be informed of the change. Also, since traffic capacity is fixed by the capacity of the dedicated circuits, networks must be constructed for peak loads resulting in unused capacity during non-peak times. This arrangement makes the network 10 difficult and expensive to manage.

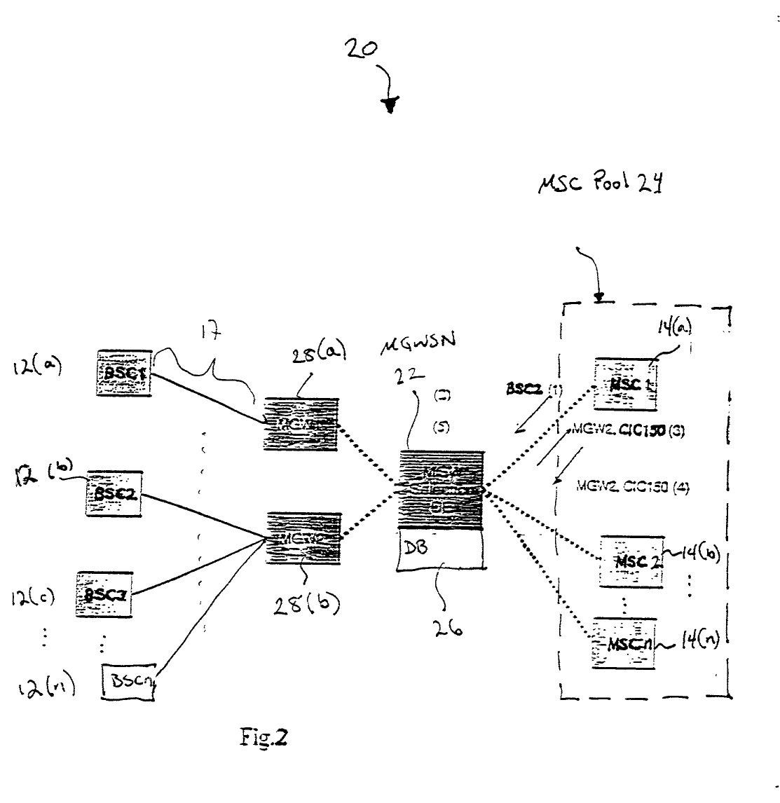

Referring to FIG. 2, a block diagram of an architecture for an improved telecommunications network 20 according to the invention and that eliminates the use of dedicated circuits 17 and the problems identified above is shown. Specifically, FIG. 2 shows MSC1 14(a) attempting to page a mobile terminal (not shown) through BSC2 12(b). As a first step, MSC1 14(a) contacts the Media Gateway Selection Node (MGWSN) 22 with a request for a circuit connection to BSC2 12(b). As shown, MSC1 14(a), along with all other MSCS 14(b . . . n) of the network 10, is a member of the MSC pool 24. The MSC pool 24, controlled by the MGWSN 22, facilitates connection of all of the BSCS 12(a . . . n) and MSCS 14(a . . . n) of the network 20 without the need for dedicated circuit 17. The MGWSN 22 provides a central means of pooling and controlling circuits in the core network such that no dedicated circuits from the BSCs to each MSC are required. In addition, an individual MSC can be added or removed from the pool 19 without the BSCs 12(a . . . n) being aware.

The MGWSN 22 has at its disposal the Media Gateway Selection Database (MGWSDB) 26, which it consults in order to identify an available circuit path between BSC2 12(b) and MSC1 14(a). Each circuit path typically has an associated CIC stored in the MGWSDB 26. The MGWSN 22 selects a circuit path identified by a unique CIC, CIC150 in this example. The MGWSN 22 also selects a Media Gateway (MGW) 28(n), in this example, MGW2 28(b) and reserves the available CIC150. The MGWSN 22 returns the identity of the MGW, in this case MGW2 28(b), and the identity of CIC150, to the requesting MSC1 14(a). At this point, the call is terminated in the typical manner so that a connection is made using CIC150 from MSC1 14(a) to MGW2 28(b) to BSC2 12(b). Of course, in most instances, the call is further terminated to an end point beyond BSC2 12(b) in order to provide a connection beyond MSC1 14(a). These end points correspond to one or user terminals such as a mobile terminal of the wireless telecommunications network 20 or a fixed terminal (POTS) of a fixed network such as the Public Switched Telephone Network (PSTN), for example.

Thus, since the MGWSN 22 acts as an intermediary between the MSCs in the pool 24 and the MGWs 28(a), 28(b), a circuit pathway can be designated and selected between any one BSC 12(a . . . n) and any one MSC in the pool 24 without a dedicated connection between each such BSC 12(a . . . n) and each such MSC. Moreover, it should be understood that after the call is released, MSC1 14(a) informs the MGWSN 22 of the completion of use of the specified circuit path through MGW2 28(b) and CIC150 to BSC2 12(b). The MGWSN 22 then updates the MGWSDB 26, indicating that CIC150 is available for reallocation. Thus, the invention contemplates dynamic allocation of non-dedicated circuits as needed between any one MSC of the pool 24 and any one of the BSCs 12(a . . . n).

It should be apparent to those skilled in the arts that the dynamic allocation of circuit paths makes possible several important advantages of the invention. For example, a new MSC 14 may be added to the network 20 without the necessity for reconfiguring any portion of the network 20. The new MSC 14 is simply added to the MGWSDB 26 and is then able to request MGW 28 and CIC allocations to connect with BSCs 12 of the network 20. Additionally, the invention provides flexibility to allocate circuit pathways in routes chosen to reduce congestion at particular nodes in the network.

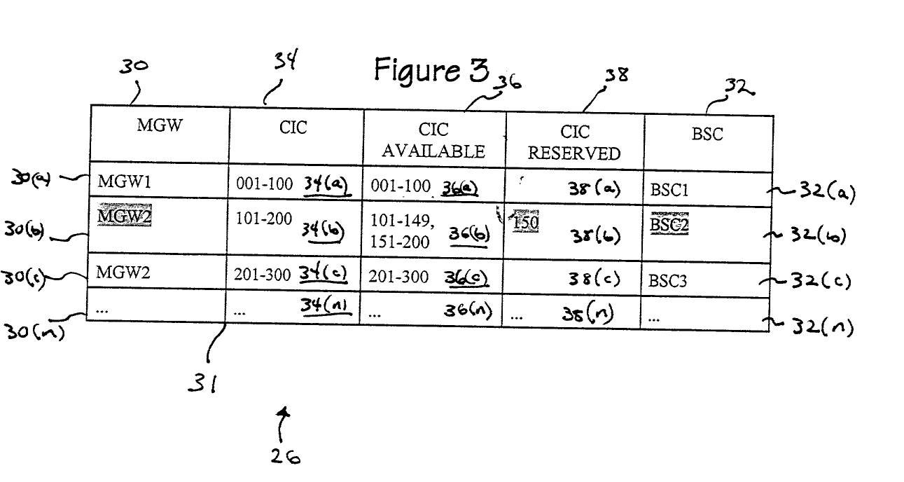

FIG. 3 is a table 31 illustrating the fields of an example media gateway selection database 26. It should be understood that FIG. 3 is a graphical representation of the nature of data which may be stored in the MGWSDB 26 using a computer-readable medium, and is not intended be a literal representation of a specific database. It will be apparent to those skilled in the arts that the MGWSDB 26 may contain operative classes, objects, functions and logic as well as static data, necessary to accomplish the functions of the MGWSDB 26. The data of the table 31 in the example of FIG. 3 also corresponds to the discussion of the example of the invention discussed with reference to FIG. 2, above.

In general, the MGWSDB 26 stores the CIC data necessary to control the allocation of circuit pathways by the MGWSN 22. The identities of the media gateways (e.g. FIG. 2, MGWs 28(a), 28(b)), are also stored therein. As shown, an MGW column 30 stores the identities of the MGWs of the network. Box 30(a) stores the identity of MGW1 and boxes 30(b) and 30(c) store the identity of MGW2. A BSC column 32 maintains records of BSC identities (e.g. FIG. 2, BSCs 12(a . . . c)) as indicated by BSC1 32(a), BSC2 32(b), and BSC3 32(c). The relationship of the rows and columns of the table 31, the respective BSCS and MGWs may be associated with one another by allocating CIC connections.

As can be seen in FIG. 3, the table 31 reflects the fact that MGW1 30(a) has been associated with to BSC1 32(a). In making this association, the MGWSN 22 has allocated connections from column 34, namely CIC001-100 34(a), for availability in completing circuit paths between BSC1 and MGW1. The allocation of CICS and the completion of circuit paths is preferably carried out dynamically as needs arise. A column 36 is provided for retaining data concerning which of the allocated CICS are available for use. Another column 38 is provided for maintaining data concerning which CICS are in use at any given time. It can be seen by the relationship of the MGW and BSC columns 30, 32, that MGW2 30(b), 30(c) has been associated with both BSC2 32(b) and BSC3 32(c). The assigned CICS are indicated in the CIC column 34 wherein CIC101-200 34(b) have been allocated to BSC2 32(b), and CIC201-300 32(c) have been allocated to BSC3 32(c).

One way data corresponding with the example discussed with reference to FIG. 2 may be conceptualized is as follows. Examining the circuit pathway of FIG. 2, it can be seen in the table 31 of FIG. 3, that MGW2 30(b) is assigned BSC2 32(b) with CIC101-CIC200 34(b) available for circuit path connections. The allotted 34(b) and available circuit paths included CIC150 38(b), chosen for making the connection between MGW1 and BSC2 of the example. The use of CIC150 38(b) for the particular circuit path of the example is recorded in the reserved CIC column 38 as long as the path remains allocated. Upon receipt of an indication that the connection is no longer required, the MGWSDB 26 is updated to indicate that CIC150 is again available, which would appear at 36(b).

In summary of FIG. 3, reading across the corresponding column entries in row (b) of the table 31, the circuit path of the example is indicated as follows: MGW2 30(b) is allocated CIC101-200 34(b); CIC101-149, and CIC151-200 36(b) remain available; and CIC150 38(b) has been reserved for connection with BSC2 32(b). Of course it will be understood that the foregoing is but one example of a graphical representation of the relationships possible within the MGWSDB 26. Many combinations or alternative graphical representations of the concept are possible without departure from the invention.

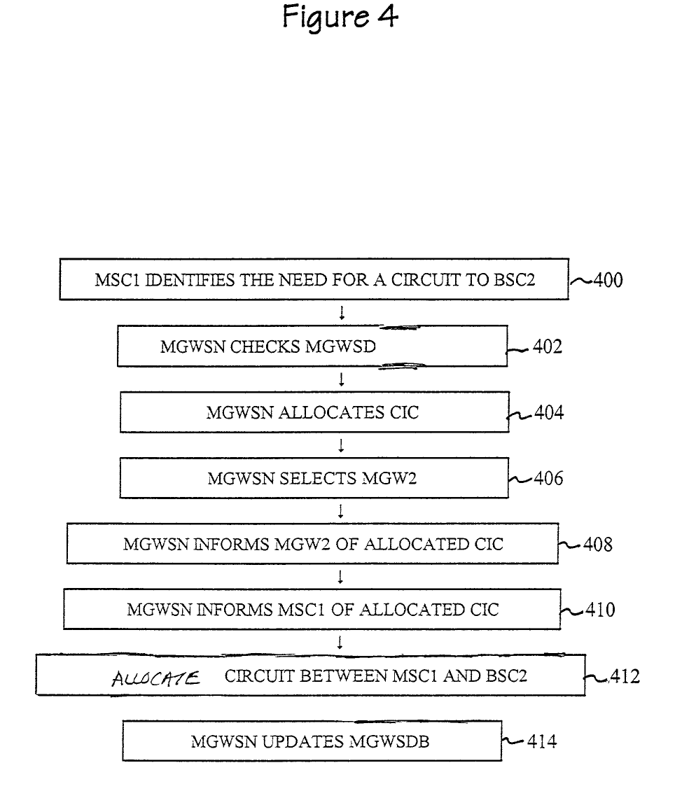

FIG. 4 is a process flow diagram showing the process of the invention consistent with the example of FIGS. 2 and 3. At step 400, MSC1 identifies the need for a circuit pathway to BSC2. At step 402, the Media Gateway Selection Node checks the Media Gateway Selection Database regarding available circuit pathways to BSC2. The Media Gateway Selection Node allocates CIC150 to BSC2 (step 404). The Media Gateway Selection Node selects MGW2 in step 406. At step 408, the MGWSN informs MGW2 of the use of CIC150 and at step 410, the MGWSN also informs MSC1 that it will be using CIC 150. In step 412, MGW2 sets up the circuit pathway between MSC1 and BSC2 via CIC150. The MGWN updates the MGWSDB in step 414. In this case, it should be understood that during the process described, the pathway between MSC1 and BSC2, using CIC150 via MGW2 will be “reserved” or otherwise indicated as in use. The Media Gateway Selection Database will be further updated upon the termination of the circuit pathway. For example, at the termination of communications between BSC2 and MSC1, MSC1 informs the MGWSN that the call is released. The resources used to create the circuit pathway for the call are then released and are again available for use in the allocation of additional circuit pathways.

The embodiments shown and described above are only exemplary. Even though numerous characteristics and advantages of the present invention have been set forth in the foregoing description together with details of the invention, the disclosure is illustrative only and changes may be made within the principles of the invention to the full extent indicated by the broad general meaning of the terms used in the attached claims.

What is claimed is:

1. A telecommunications network providing non-dedicated circuit pathways between access nodes and switches in the network comprising:
a plurality of access nodes disposed about a service area of the telecommunications network;
a switch pool adapted to communicate with the access nodes in order to provide access by a plurality of user terminals to services of the telecommunications network;
at least two gateways providing one or more connections between the access nodes and the switch pool via a plurality of circuit pathways; and
a gateway selection node operably coupled to the gateways and the switch pool, the gateway selection node configured to reserve and release circuit pathways as needed for use between switches of the switch pool and the access nodes.

2. The network of claim 1 wherein the switches comprise Mobile Switching Centers (MSCS).

3. The network of claim 1 wherein the access nodes comprise Base Station Controllers (BSCS).

4. The network of claim 1 wherein the access nodes comprise Radio Network Servers (RNSs).

5. The network of claim 1 wherein the gateway selection node further comprises a data structure defining relationships among gateways, access nodes, and identity codes associated with the circuit pathways.

6. The network of claim 4 wherein the data structure comprises a media gateway selection database.

7. The network of claim 1 wherein the identity codes comprise Circuit Identity Codes (CICS).

8. A method of providing non-dedicated circuit pathways between access nodes and switches in a telecommunications network having a plurality of gateways, the method comprising the steps of:
requesting a circuit pathway between a switch and a target access node;
selecting a circuit pathway between the switch and target access node;
allocating a circuit pathway between the switch and a selected gateway;
allocating a circuit pathway between the selected gateway and target access node; and subsequently,
de-allocating the circuit pathway between the switch and selected gateway; and
de-allocating the circuit pathway between the selected gateway and target access node.

9. The method of claim 8 wherein the steps of selecting, allocating, and deallocating are performed dynamically.

10. The method of claim 8 further comprising the step of maintaining a media gateway selection node for selecting, allocating, and de-allocating circuit pathways.

11. The method of claim 10 further comprising the step of maintaining a switch pool comprising the switches of the telecommunications network, the switch pool operably connected to the media gateway selection node.

12. The method of claim 10 further comprising the step of maintaining a data structure defining relationships among gateways, access nodes, switches, and identity codes.

13. A media gateway selection node for use in a telecommunications network for providing non-dedicated circuit pathways between access nodes and switches of a switch pool in the network, comprising:
means for storing and accessing data concerning media gateways, access nodes, switches, and circuit pathways of the network;
means for defining relationships among the media gateways, access nodes, switches, and circuit pathways; and
means for reserving and releasing circuit pathways as needed for use between individual switches and individual access nodes.

14. A media gateway selection node according to claim 13 wherein the data concerning media gateways, access nodes, switches, and circuit pathways, further comprises load carrying capacity.

15. A media gateway selection node according to claim 13 wherein the means for defining relationships among the media gateways, access nodes, switches, and circuit pathways is adapted to perform dynamically.

16. A media gateway selection node according to claim 13 wherein the means for reserving and releasing circuit pathways as needed for use between individual switches and individual access nodes is adapted to perform dynamically.
